(19) United States
(12) Patent Application Publication
(10) Pub. No.: US 2009/0231117 A1
(43) Pub. Date: Sep. 17, 2009

(54) SYNCHRONIZATION IN A MULTI-PANEL ALARM SYSTEM

(75) Inventor: Jordan S. Cohen, Collegeville, PA (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: Viking Electronic Services, LLC, Grand Rapids, MI (US)

(21) Appl. No.: 12/047,438

(22) Filed: Mar. 13, 2008

(51) Int. Cl. G08B 23/00

(52) U.S. Cl. 340/502; 340/501

(57) ABSTRACT

An alarm or security system (10) employs sensors (12) interspersed throughout a building (B). Groups of the sensors are connected to respective control panels (P1-Pn) which are interconnected with each other for communications therebetween. Each control panel operates audio annunciators (20) for sounding an audio alarm when a sensor goes into alarm, as well as visual indicators (22) for providing a visual indication of an alarm condition. A method of synchronizing the sounding of the audio alarm and providing the visual indication includes designating one control panel a master panel (M) and the other panels as slave panels (S). The master panel generates a command signal for activating the audio annunciators and visual indicators to produce an audible alarm and a flashing light each of which separately indicates an alarm situation within the building. This signal is transmitted from the master panel to each slave panel for all of the panels to simultaneously activate the audio annunciators and visual indicators controlled by the respective panels so audio and visual alarms occur at simultaneously throughout the building.

### CROSS REFERENCE TO RELATED APPLICATIONS

None

### STATEMENT REGARDING FEDERALLY SPONSORED RESEARCH OR DEVELOPMENT

N/A

### BACKGROUND OF THE INVENTION

This invention relates to fire alarm and security systems; and more particularly, to a method for synchronizing audio and visual alarms throughout a facility.

As is well-known, large facilities in which fire alarm or security systems are installed are typically divided into zones or regions. Sensors installed within each zone are connected in a loop to a control panel. As a consequence, a large building will include multiple control panels.

When a sensor such as a fire sensor goes into alarm, a number of things simultaneously occur. One is that the control panel generates an alarm signal which is transmitted to a monitoring site to alert the monitors of the alarm condition. This results in appropriate responders being sent to the facility to deal with the alarm situation. Another is that an audio alarm (a klaxon) is activated to produce a loud, piercing sound to alert people of the alarm condition. A visual alarm is also simultaneously activated for the same reason. Usually the alarms (both audio and visual) are sounded throughout the facility, even though persons in parts of the building may be well away from any potential danger.

It has been found that in certain instances; for example atrium type buildings such as some hotels, that there is a slight, but noticeable, difference in timing between when the audio and visuals alarms occur in one part of the building, and when they occur in another part of it. It has further been found that this disparity can, in some people, trigger a reaction which impairs their ability to respond to the alarm situation. They may, for example, become disoriented and unable to locate or move to an emergency exit.

The present invention is directed to a method of identifying this situation when it occurs and modifying operation of the alarm system to synchronize the alarms throughout the facility. In this regard, it is known to synchronize multiple audio and visual alarms which are connected together in a single two-wire control loop. Such a synchronized system is described in U.S. Pat. Nos. 7,079,011, 6,906,616, 6,583,718, 6,369,696, 6,194,994, 5,982,275, 5,751,210, and 5,608,375, all of which are assigned to Wheelock, Inc. of Long Branch, N.J. However, it has heretofore not been known how to synchronize such alarms which they are connected to separate control panels located throughout a building and are geographically remote from each other.

### BRIEF SUMMARY OF THE INVENTION

The present disclosure is directed to a method of synchronizing the operation of fire alarm control panels installed throughout a building and the control of peripheral alarm devices such as audio annunciators and visual alarms. Multiple fire, security, industrial process, and peripheral controls are networked together by hardwire, fiber optics, wireless systems, and the internet. Control of these systems allows the various annunciators to provide sound or visual alarm indications to operate synchronously across the various panels throughout the facility, regardless of the proximity to one another.

Synchronization of the system will have the various audio and visual devices operating within ten milliseconds (10 msec) and preferably 3 msec of each other. This is accomplished by designating one of the panels as a master timekeeping panel and slaving the other panels in the building off timing signals emanating from this panel. The times at which the devices associated with each panel are activated is sensed and this information is compared the timing of the occurrence of the timing signal from the master panel. If there is a drift in the timing between panels, this is monitored and corrective action is taken to re-synchronize the panels to within acceptable timing range.

The method further continuously monitors operation of the designated master panel. If it appears that the master panel, for some reason, is not functioning properly, there is a transfer of the synchronization from this panel to another panel which then becomes the master panel for maintaining the synchronization. In addition, if the alarm or security system is expanded with additional control panels being added to the overall system, inclusion of the new panels into the synchronization scheme is readily accommodated.

Other objects and features will be in part apparent and in part pointed out hereinafter.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 is a simplified representation of a building in which an alarm or security system of the present invention is installed;

FIG. 2 is a block diagram representation of the control panels with a designated “master” panel supplying command signals to “slave” panels to activate audio and visual annunciators controlled by each panel in synchronism;

FIG. 3 is a timing chart illustrating the timing synchronization between the master and slave panels; and,

FIG. 4 is another timing chart illustrating the transfer of responsibility for synchronization from the master panel to another panel if the master panel gets out of synchronization.

Corresponding reference characters indicate corresponding parts throughout the several views of the drawings.

### DETAILED DESCRIPTION OF INVENTION

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

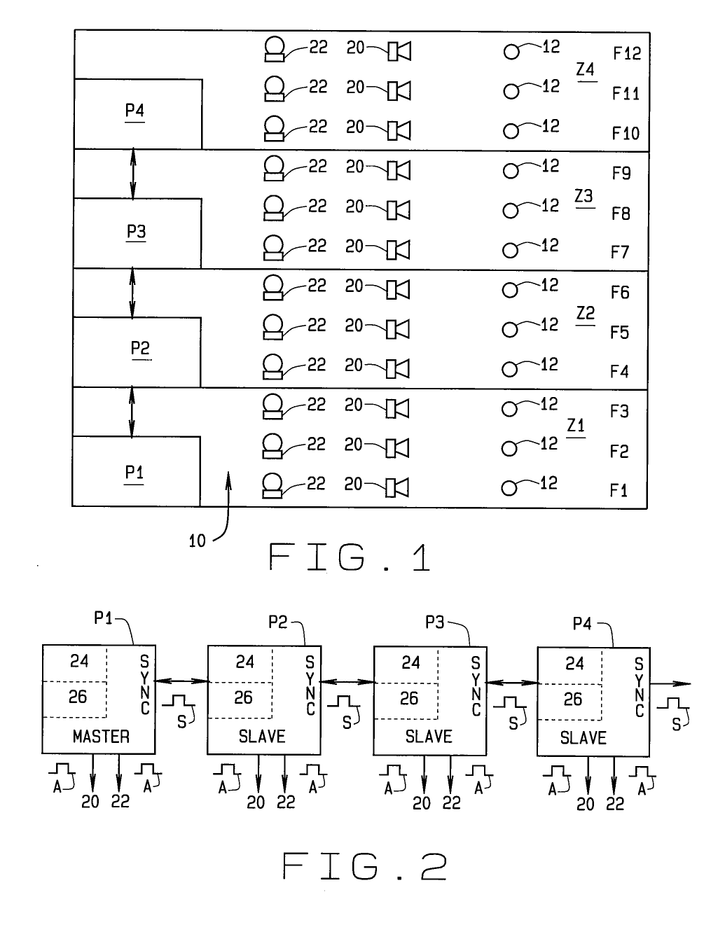

Referring to the drawings, in FIG. 1, an alarm or security system 10 is installed in a multi-floor building B, especially atrium type multi-floor buildings. In FIG. 1, building B is shown to have twelve floors F1-F12, although this is exemplary only. For installation of system 10 in the building, building B is divided into four zones Z1-Z4, with each zone covering three floors of the building. Again, this is representative only. System 10 employs a plurality of sensors 12 which are interspersed throughout the building with one or more of a particular sensor or detector being installed at selected locations on each floor. As is well-known in the art, the sensors can be of various types including fire or smoke detectors, sensors for detecting the opening of doors or windows, etc. Groups of the same sensors are typically arranged in loops with the loops of sensors within a particular zone being connected to a respective control panel P1-P4 for that zone. As shown in FIGS. 1 and 2, the control panels are interconnected with each other for communications between them.

As is known in the art, when a sensor such as a fire detector goes into alarm, in addition to an indication thereof being sent to a monitoring location to notify system monitors of the alarm, an alarm is sounded within the building to alert people in the building of the alarm condition. There are two types of alarms or annunciators used for this purpose. One is an audio alarm 20 such as a klaxon or the like which continuously or near-continuously emits a loud, distinctive noise. The other is a visual alarm 22 such as a flashing light or strobe which continuously flashes on and off. Typically, alarm or security system 10 simultaneously activates both types of annunciators which continue in operation until subsequently deactivated or disabled in accordance with an established protocol. Preferably, all the audio alarms and all the visual alarms should operate in synchronism. As previously noted, studies have found that a asynchronous operation of these devices can produce harmful effects in some individuals which may impair their ability to adequately respond to an alarm situation in which they find themselves.

In accordance with the method of the invention, and as shown in FIG. 2, one of the control panels; for example, control panel P1 is designated as a “master” panel and the other panels P2-P4 are designated “slave” panels. This means that when an alarm or security situation occurs, the master panel will generate and supply a command synchronization signal S to all the other panels, and all four panels will synchronize operation of the annunciators under their control to this signal. That is, the signal S transmitted from master panel P1 to each slave panel P2-P4 results in all of the panels simultaneously supplying an activation signal A to activate the respective audio annunciators 20 and visual indicators 22 controlled by them so the audio and visual alarms occur simultaneously throughout the building.

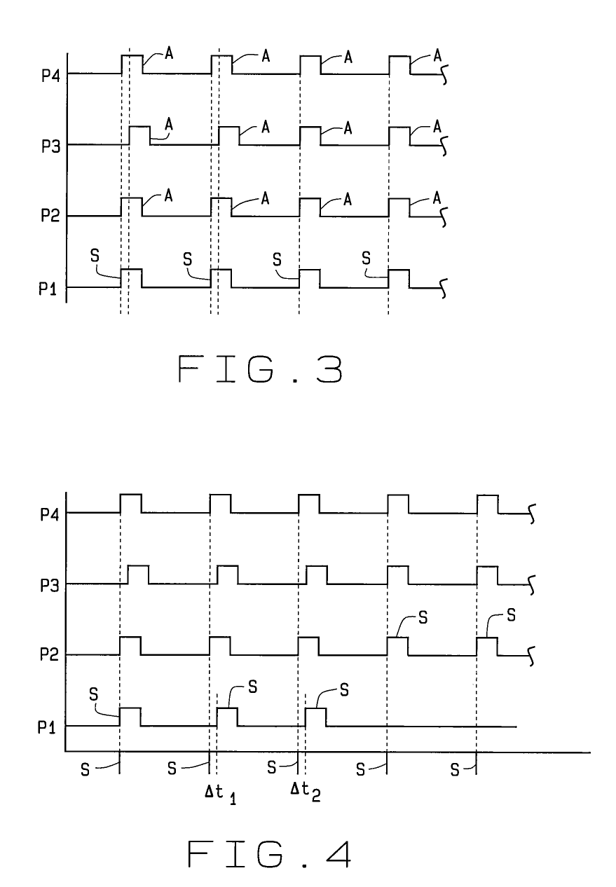

The method of the invention next includes comparing the activation signal A from each slave panel with the command signal to determine if the activation signal occurs within a predetermined window of time relative to receipt of the command signal. For this purpose, master panel P1 (as does each panel) includes a comparator module 24 which compares the timing of the command to that of the activation signal produced by each slave module. Referring to FIG. 3, command signals are generated by master panel P1 at a predetermined interval or frequency. In accordance with the method, the activation signals A produced by the slave panels should occur substantially simultaneously with the generation and supply of the command signals S. This is as shown in the Fig. However, it may occur that the generation of activation signals A by a slave panel (see the signals A for panel P3 in FIG. 3, may be delayed by some amount so that there is a time difference Δt between the occurrence of command signal S and the activation signal A by that panel.

In such instance, each panel includes a timing adjusting module 26 which allows it to adjust the occurrence of the activation signals A produced by that panel so they again coincide with occurrence of the master panel. In this regard, there is a time window of ±10 milliseconds (msec), and preferably ±3 msec., built into system 10 before an adjustment needs to be made. As shown in FIG. 3, for control panel P3, once the variance Δt is sensed in comparator module 24, the adjusting module 26 in panel P3 is commanded by control panel P1 to adjust the timing within the control panel so the activation signals generated by that control panel again occur in synchronism with command signal S and the activation signals A produced by the other control panels.

Next, it sometimes occurs that the master panel initially selected becomes inoperative or begins to malfunction so that it is unable to produce and transmit command signals S at the predetermined frequency. In this instance, alarm or security system 10 is programmed to automatically re-designate one of the slave panels as the master panel with this newly designated master panel now transmitting the command signal S to all the other panels.

Referring to FIG. 4, the command signal S produced by control panel P1 is shown to, over time, begin lagging the time at which the signal should be produced for the predetermined frequency or interval. If this interval which is Δt1 at one period of time cannot be adjusted back to be coincident with the time at which command signal S is to occur, or if the interval begins to increase from Δt1 to Δt2, then as shown in FIG. 4, the master panel designation is switched from control panel P1 to control panel P2. If this occurs, control panel P1 now becomes a slave panel; while the other control panels remain as slave panels.

Finally, and also as shown in FIG. 4, if, as noted above, control panel P1 becomes inoperative so that no command signal is produced by the control panel, then system 10 again automatically re-designates one of the other control panels as the master panel. In FIG. 4, this again is control panel P2. Once another control panel has been designated as the master panel, the other operational features of system 10 and the method of the invention are still carried with respect to the comparison of the activation signals and possible adjustment of them.

In view of the above, it will be seen that the several objects and advantages of the present disclosure have been achieved and other advantageous results have been obtained.

Having thus described the invention, what is claimed and desired to be secured by Letters Patent is:

1. In an alarm or security system employing a plurality of sensors interspersed throughout a building, respective groups of the sensors being connected to respective control panels, the control panels being interconnected with each other for communications therebetween, each control panel operating at least one audio annunciator for sounding an audio alarm when a sensor goes into alarm and/or at least one visual indicator for providing a visual indication of the alarm, a method of synchronizing the sounding of the audio alarms and/or generation of the visual indications comprising:
designating one of the control panels a master panel and the other panels as slave panels controlled by the master panel;
the master panel generating a command signal for activating the audio annunciator to sound an audible alarm and for activating the visual indicator to generate a visible light, the audible alarm and the light each separately indicating an alarm condition within the building; and,
transmitting the command signal from the master panel to each of the slave panels for all of the panels to substantially simultaneously activate their associated audio annunciator and visual indicator so that the audio and visual alarms occur at substantially the same time throughout the building.

2. The method of claim 1 wherein each panel controls operation of a plurality of audio annunciators and/or visual indicators all of which are simultaneously activated upon receipt of the command signal.

3. The method of claim 1 further including each slave panel generating an activation signal for each annunciator and/or visual alarm indicator each time a command signal is received from the master panel, each activation signal being transmitted back to the master panel.

4. The method of claim 3 further including comparing the activation signal from each slave panel with the command signal to determine if the activation signal occurs within a predetermined window of time relative to receipt of the command signal.

5. The method of claim 4 further including adjusting the timing of the generation of the activation signal by a slave panel if the activation signal is determined to be occurring outside the window.

6. The method of claim 5 in which the activation signal should occur within ±10 milliseconds of the occurrence of the command signal.

7. The method of claim 6 in which the activation signal should occur within ±3 milliseconds of the occurrence of the command signal.

8. The method of claim 1 in which each command signal is generated and transmitted to each of the panels at a predetermined frequency.

9. The method of claim 8 further including re-designating a slave panel as the master panel if the initial master panel becomes inoperative or is otherwise unable to produce and transmit command signals at the predetermined frequency.

10. The method of claim 1 in which the building is an atrium type, multi-floor building with a control panel installed on designated floors.

11. In an alarm or security system employing a plurality of sensors interspersed throughout a building, respective groups of the sensors being connected to respective control panels, the control panels being interconnected with each other for communications therebetween, each control panel operating at least one audio annunciator for sounding an audio alarm when a sensor goes into alarm and/or at least one visual indicator for providing a visual indication of the alarm, the improvement comprising:
one of the control panels operating as a master panel and each of the other panels operating as a slave panel controlled by the master panel;
a command signal generator in the master panel generating a command signal for activating the audio annunciator to sound an alarm and for activating the visual indicator to generate a visible light, the audible alarm and the light each separately indicating an alarm condition within the building; and,
a transmitter within the master panel transmitting the command signal from the master panel to each of the slave panels for all of the panels to substantially simultaneously activate their associated audio annunciator and visual indicator so that the audio and visual alarms occur at substantially the same time whereby the audio alarms and visible alarm indications are synchronized throughout the building.

12. The improvement of claim 11 wherein each panel controls operation of a plurality of audio annunciators and/or visual indicators all of which are simultaneously activated upon receipt of the command signal.

13. The improvement of claim 11 further including a signal generator on each slave panel responsive to the command signal for generating the activation signal for each annunciator and/or visual alarm indicator, the signal generator also transmitting each activation signal back to the master panel.

14. The improvement of claim 13 further including a comparator at the master panel comparing the timing between the transmission of a command signal and the generation of the resulting activation signal at each slave panel to determine if the activation signal occurs within a predetermined window of time relative to receipt of the command signal.

15. The improvement of claim 14 further including a controller adjusting the timing of the generation of the activation signal by a slave panel if the activation signal is determined to be occurring outside the window.

16. The improvement of claim 15 in which the controller controls operation of each slave panel for each activation signal to occur within ±10 milliseconds of the occurrence of a command signal.

17. The improvement of claim 16 in which the controller controls operation of each slave panel for each activation signal to occur within ±3 milliseconds of the occurrence of a command signal.

18. The improvement of claim 11 in which the controller further controls operation of the master panel do each command signal is generated and transmitted to each of the panels at a predetermined frequency.

19. The improvement of claim 15 in which the controller is responsive to the master panel becoming inoperative or otherwise unable to timely generate command signals to transfer control of the system to one of the slave panels which then becomes the master panel.

20. In an alarm or security system for an atrium type, multi-floor building, the system including control panels installed on designated floors of the building, the system having at least one alarm sensor located on each floor of the building with respective groups of the sensors being connected to a respective control panel, the control panels being interconnected with each other for communications therebetween, and each control panel operating at least one audio annunciator for sounding an audio alarm when a sensor goes into alarm and/or at least one visual indicator for providing a visual indication of the alarm, apparatus for synchronizing operation of the control panels comprising:
a system controller designating one of the control panels to operate as a master panel and each of the other panels to operate as a slave panel controlled by the master panel;
a command signal generator in the master panel generating a command signal for activating the audio annunciator to sound an alarm and for activating the visual indicator to generate a visible light, the audible alarm and the light each separately indicating an alarm condition within the building; and,
a transmitter within the master panel transmitting the command signal from the master panel to each of the slave panels for all of the panels to substantially simultaneously activate their associated audio annunciator and visual indicator so that the audio and visual alarms occur at substantially the same time whereby the audio alarms and visible alarm indications are synchronized throughout the building.

21. The apparatus of claim 20 further including a signal generator on each slave panel responsive to the command signal for generating the activation signal for each annunciator and/or visual alarm indicator, the signal generator also transmitting each activation signal back to the master panel.

22. The apparatus of claim 21 further including a comparator at the master panel comparing the timing between the transmission of a command signal and the generation of the resulting activation signal at each slave panel to determine if the activation signal occurs within a predetermined window of time relative to receipt of the command signal, the controller adjusting the timing between each command signal and the resulting activation signal by a slave panel if the activation signal is determined to be occurring outside the window.

23. The apparatus of claim 20 in which the controller is responsive to the master panel becoming inoperative or otherwise unable to timely generate command signals to transfer control of the system to one of the slave panels which then becomes the master panel.
